(19) United States
(12) Patent Application Publication
(10) Pub. No.: US 2002/0138361 A1
(43) Pub. Date: Sep. 26, 2002

(54) System and method for e-commerce business

(75) Inventor: Sy-Yuan Chen, Taipei (TW)

Correspondence Address: DOUGHERTY & TROXELL, 5205 LEESBURG PIKE, SUITE 1404, FALLS CHURCH, VA, 22041, US

(73) Assignee: Payeasy Digital Integration Co., Ltd.

(21) Appl. No.: 09/945,716

(22) Filed: Sep. 5, 2001

(30) Foreign Application Priority Data
Mar. 20, 2001 (TW) 90106404

(51) Int. Cl. G06F 17/60

(52) U.S. Cl. 705/26

(57) ABSTRACT

A system and method for e-commerce business, which is an e-commerce payment system that effectively combines membership function, cash flow, logistic and information flow. The payment means of the system utilizes that “Member Number Management”, “Member Business Cipher Code Check” and “The Direct Security Encryption Means Between Card Holder and The System” to solve the problem of real time credit card authorization in cash flow of e-commerce business. “A credit card fund-request file is produced depending on actual delivery condition of order list”, and the shortness of ordered goods not in stock, refund process and goods delivery and fund-requests time after time is totally figure out. The consumer right is protected on network purchasing.

### BACKGROUND OF THE INVENTION

1. Field of the Invention

This invention is about a system and method for e-commerce business, especially consumer deals with a Network merchant via Network, and there is no need to input credit card number all the times or even store the related information in the server of the Network merchant, therefore, the risk for the credit information being stolen is lowered.

2. Background of the Invention

As the time being, information and network technology is growing up and spreading rapidly, and consumers' deal with Network merchants via Network are more and more gradually. Although Network merchant includes the following merits: non-restriction area, all over the world for consumers, no merchant fabrication fee, much lower than reality for set-up cost, 24-hour service without salesclerk, lower running cost, lower cost for stock and display, etc. At the present time, consumers still consider the safety for Network business, and the most important key is that the payment means cannot be trust strongly.

Please refer to FIG. 1, which represents the typical payment model of the present regular e-commerce business. When a client 11 connects to a merchant 12 via Network and chooses merchandise, the following procedure is the Network payment method. The most common e-commerce system for Network payment method is that a merchant 12 (or an ISP) designs a payment means 13 (or payment server) for consumer inputting personal authorization information that as credit card number, effective date, holder name, payment amount, etc. Then, the information is delivered to the merchant 12 (flow 111) through Network. Merchant 12 transfers the information to a receiving bank 14 or issuing bank by way of a payment means 13 of prior art to identify the affectivity and credit limit (flow 112). After identification, the authorization result is back to merchant 12 along the same path (flow 113). Merchant 12 confirms that and responds to consumer 11 for succeeding the merchandise order via Network (flow 114).

On the other hand, there are some shortcomings shown in FIG. 1 which as following:

(1) The present Network merchants 12 provide the payments 13 to deliver the authorization information which are unencrypted codes, and the information is possibly intercepted and stolen within delivery. Therefore, the possibility for being stolen personal information on e-commerce business is higher if consumer deals with Network merchants more often. Another words, they are direct proportional to each other.

(2) So far, the payment means runs the procedures of shelling out at merchant 12, thus even part of authorization information is encrypted in delivery, merchant 12 decodes the encrypted part to store in database for continuous credit authorization procedures. Which means a consumer has been dealt with 100 Network merchants, the merchants are keeping the consumer's information. If there are some merchants or even one merchant illegally uses the credit authorization or one of them is interfered by hackers, and that is extremely risky. Further, both merchant 12 provides the payment means 13 and servers, and not all of them are able to offer enough technology, finance, and professional moral to supporting encryption means for protecting consumers. Hence, the more times to purchase on Network is highly raised the percentage to be stolen the information.

(3) The present Network payment means is engaged in merchant system, and issuing bank (or receiving bank) depends on the purchasing amount of credit authorization information form merchant 12 to pay the same amount. However, not each order can be delivered to consumer 11 on time, for example, some good are not in stock. The regular payment means 13 is that merchant 12 applies the amount to issuing banks (or receiving bank 14) based on the total consuming amount, for the lately delivered goods, they are refunded additionally. As a matter of factor, the people who are familiar with credit card process, the refunded method forces consumer pay off the total balance on credit card bill in the first month, and the refunded amount is just listed on the following monthly bill. This is not only in convenient to consumer, but also issuing bank and merchant are complained (the amount on credit card bill is different than the amount of purchasing).

(4) The present Network payment means is engaged in merchant system, in case of a new payment means (as updated version which is faster, saver and more standard) is utilized for on-line payment and credit authorization identification, each merchant system has to be updated individually, thus the difficulty and cost are high.

(5) The current Network merchant system supplies consumer checking the list of ordered merchandise and delivered merchandise, but the applying information of merchant 12 is restricted that issuing bank database cannot integrated merchant 12, thus consumer cannot check the related information in issuing bank database. This is not only inconvenient to consumer, but also the check for payment and goods-receiving, thus consumer right is not in protection. So, the further improvement is a need.

### SUMMARY OF THE INVENTION

The first object of the invention is to supply an e- commerce business system and method, the meaning is that when consumer purchasing merchandise from Network merchants via Network, personal credit authorization information does not be input time after time and even stolen in merchant, and the risk for credit card information being stolen is lower.

The second object of the invention is to supply an e- commerce business system and method, the meaning is that merchant does not offer on-line payment means and the means is instead of an independent e-commerce business system when on-line business is in execution. The said e-commerce business system supplies member codes and ciphers for being instead of personal credit authorization information. And, the e-commerce system executes the check for credit authorization and funs-request from merchant, those avoid that credit card information is stored in many different store databases, on the other hand, the possibility for credit card being stolen is highly lowered and merchant requests funds depending on actual delivery conditions. Thus, the additional refund process in prior art does no longer exist.

The third object of the invention is to supply an e-commerce business system and method, the meaning is that merchant requests funds from the e-commerce business system based on actual delivery conditions. The database in the system stores all information related to credit authorization information, order list, actual delivery list, fund-request list, etc. Consumer could check ordered merchandise, actual delivered merchandise and payment list.

The fourth object of the invention is to supply an e-commerce business and system and method, the meaning is that an on-line payment means is offered by an independent e-commerce business system, therefore, the e-commerce business system is the only one to be updated when the whole operating system needs to be updated, and all merchants and consumers are in the convenience of the invention. Cost and difficulty updated on-line payment means are greatly decreased.

### BRIEF DESCRIPTION OF THE DRAWINGS

FIG. 1 is the structure in prior art, describing the relationship among the e-commerce business system in merchant, consumer and credit card issuing bank.

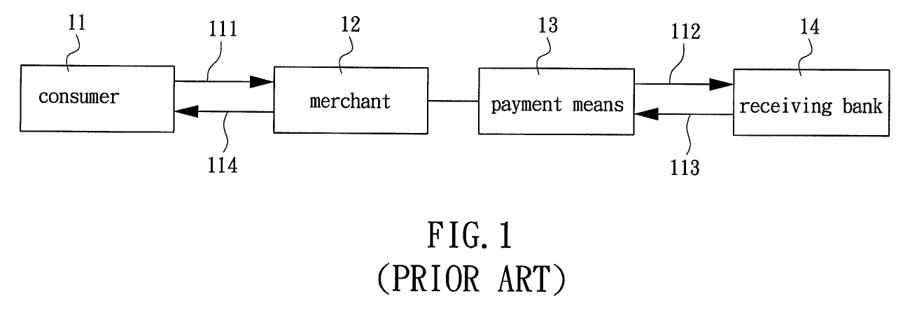

FIG. 2 is the preferred embodiment of an e-commerce business system of the invention, describing the relationship among the e-commerce in the invention, merchant and consumer.

FIG. 3 is the embodiment for that consumer is not a member, but still dealing with an e-commerce business of the invention, or consumer is only a member in merchant.

FIG. 4 is the preferred embodiment of an e-commerce business system structure of the invention.

FIG. 5 is one merchant system of an e-commerce business system of the invention.

### DETAILED DESCRIPTION OF THE PREFERRED EMBODIMENT

The system and method for e-commerce business are to supply an independent e-commerce business system to manage on-line payment, thus the shortness in prior art that Network merchant self providing on-line payment means with directly connecting to credit card issuing bank can be replaced. Via the e-commerce business system of the invention, consumer inputs a “member code” and “cipher code”, which are applied in advance, on an on-line payment means to be instead of credit card information when on-line payment service is engaged. The “member code” and “cipher code” are encrypted to be delivered into the e-commerce business system via Network, and not exist in merchant. The e-commerce business system checks and identifies “member code” and “cipher code”, and authorizes or non-authorizes the business. If the business authorized, merchant engages an action of fund-request, and not only the fund-request is via the e-commerce business system, but also the fund-request amount is based on actual delivery conditions for avoiding refund process.

The following embodiments are for further understanding to the features and effects of the invention.

The nouns' definitions:

Network Media: providing networks media or method for computer message exchange, transmitting, etc. The said network is possibly Internet, Intranet, ISDN (integrated service digital network), PSTN (public switched telephone network), Cable Network, Radio Communication, etc.

Consumer: broadly involving people who can log-in or brows Internet shops and web, and further explain for people is that including purely browsers and actual on-line shopping persons.

Merchant: broadly covering Internet business sites or Webs that engage purchasing, on-line services or payment etc., or they could call EC Shops.

System: providing computing equipment for network connecting to, web-site installation, data storing, numerical and logical computing and offering browsers log-in and utilizing all software and hardware means.

Web-Site: the interfaces and means for that consumer browse web pages and utilize system's functions.

Electronic Transmission of Money: another call is On-Line Payment, which including digital business means. For instance, inputting credit card authorization information to deduct, or e-wallet, account transferring in banks, etc.

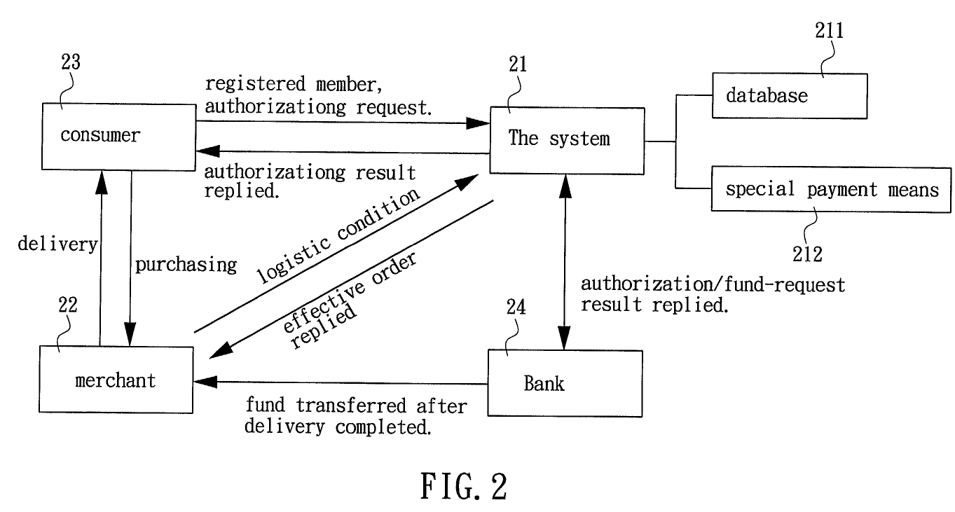

Please refer to FIG. 2, which is the preferred embodiment of an e-commerce business system of the invention. FIG. 2 describes the relationships among the e-commerce business system 21, merchant 22, consumer 23 and credit card issuing bank 24.

The e-commerce business system 21 for the invention (simplified call the system 21 as following) which electronic payment means is via credit card number management and encryption means to solve the cash flow problems on e-commerce. Consumer 23 has to register in the system 21 for being a member in advance. The credit information (including credit card number, holder name, expiration date, etc.) is saved in secure system (database 211). When consumer 23 connect to other Internet merchants, the only procedure is to input member code (account number) and cipher code of the system 21 in special payment means 212, and the credit authorization from bank is then gotten through the system 21 to finish the business. Following the system 21, the merchant 22 is no possibility to be used for transmitting and storing credit authorization information. A point is the special payment means 212 is part of the system 21, and it is attached into web-site, homepage or any other html device by embedded code. When consumer clicks on the execution code, the code calls the special payment means 212 of the system 21 to execute on the browser of consumer 23 (now, merchant 22 does not know what the special payment means 212 is working on.). Thus, the input credit authorization information by consumer 23 is directly transmitted to the system 21. Meantime, order list is with credit authorization information to be sent to the system 21 together. When the system 21 proves the credit authorization information, a reply from the system 21 to merchant 22 is to notify the result of effective order and the delivery information (including order list) is sent back to merchant 22 for confirmation. After, merchant 22 transmits actual delivery list to the system 21 based on actual delivered goods, and then a fund-request to bank 24 through the system 21 is proceeded, thus the money is transmitted to merchant 22 in direct. The amount of fund-request can be transmitted time after time for avoiding complicate refund process. On the other hand, the amount of multiple fund-request from merchant 22 cannot be over the total limit authorization amount of consumer 23.

There are three important points in the preferred embodiment:

Via the special payment means 212 of the system 21, all consumer credit cards and personal information are no longer transmitted or stored through merchant 22.

In the preferred embodiment, the system 22 encrypts all exchange data with 128 bits SSL to transmit, or the encryption method can be others.

The system 21 provided by professional cash flow on network designer is with more complicate fire wall design; hackers hardly steal any consumer information in the system 21.

From the above mention, in the e- commerce business system of the invention, on-line payment means is not installed by merchant when consumer engaging on-line purchasing. Thus, the on-line business is executed by an independent e-commerce business system and the independent e-commerce business system offers “member codes” and “cipher codes” to consumers for being instead of consumers' credit card information to transferred on Internet. Further, credit authorization check and fund-request receiving from merchants are also executed by the e-commerce business system to avoid both situations that consumers' credit card information are stored in many different merchants' databases and the possibilities for credit card being stolen. On the other hand, the e-commerce business system accepts the fund-request from merchants time after time depending on actual delivery conditions to avoid complicate refund process in prior art.

Fund-request from the e-commerce business system to merchants depends on actual delivery conditions (goods flow). The database in the e-commerce business system stores all credit authorization information, order list, actual delivered goods list and fund-request list from merchant, etc. Thus, consumers easily search ordered goods, actual delivered goods and payment list.

Besides, the system support on-line payment means, and there is an embedded call-to-start code on each merchant, therefore, by the time of the system being updated or upgraded, only the e-commerce business system has to do so and all other merchants and consumers could share the convenience immediately, the on-line payment means update cost and difficulty are highly decreased.

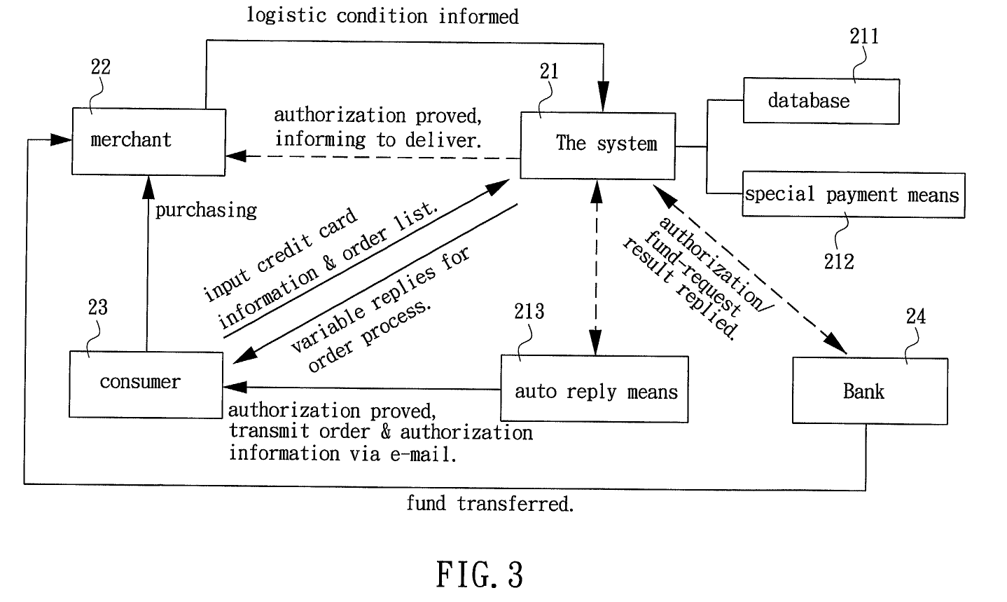

Please refer to FIG. 3, the invention is not restricted by that consumer should register to be a member of the system 21 in advance, and it is also suitable that consumer is not a member of the system 21 or a member of the merchant 22.

As showing in FIG. 3, when consumer 23 is not a member of the system 21, consumer clicks on the special payment means 22 of the system 21 on the merchant 22 via network connection and the following procedure is that clicking on the input credit card information icon to start a process for consumer inputting credit authorization information (including credit card number, holder name, expiration date, etc.). The information is encrypted firstly and directly transferred to a temp database in the system. The system 21 applies an authorization to bank based on the information. After confirming the information effective, the system 21 replies to merchant 22 for delivery. Meantime, the system transmits order and proved credit authorization to consumer 23 via an in-time auto reply means 213, and merchant 22 transmits the actual order condition to consumer 23 via in-time auto reply means 213. Thus, for the e-commerce business system 21 of the invention, even consumer 23 directly inputs credit card information and the information may not be left in the database of merchant 22.

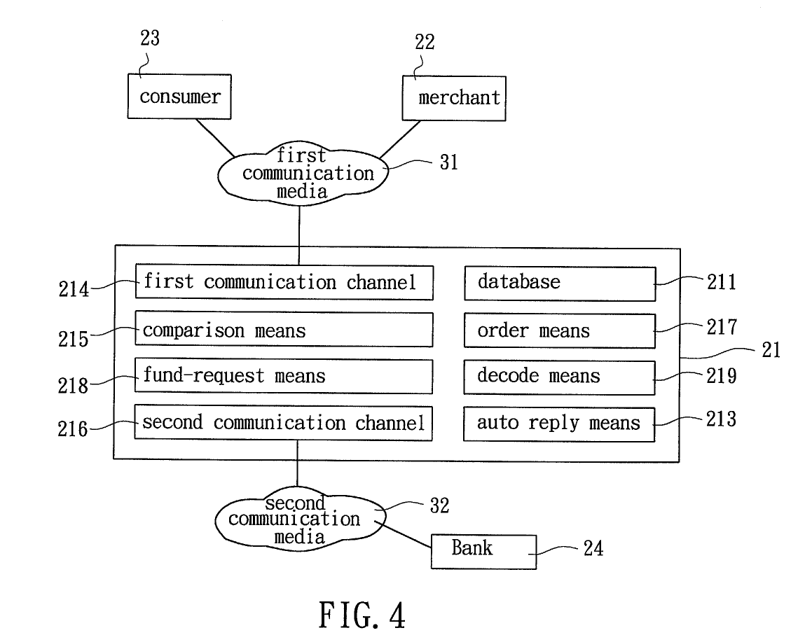

Please refer to FIG. 4, which is the preferred embodiment of the e-commerce business system 21 structure of the invention. The e-commerce business system 21 connect to at least one consumer 23 and one merchant 22 via a first communication media 31 (as the aforesaid network communication media), and further connect to a bank 24 (credit card issuing bank or credit card receiving bank) via a second communication media. The system 21 (which is the system of the invention) includes: a first communication channel 214, a database 211, a comparison means 215, a second communication channel 216, an order means 217, a fund-request means 218, an auto reply means 213 and a decode means 219.

The first communication channel 214 communicates with the first communication media 31 and at least receives credit authorization information from the first communication media 31. In the preferred embodiment, the credit authorization information includes a check code at least. When consumer 23 connect to merchant 22 via the first communication media 31 and executes on-line payment (electronic payment), consumer 23 transmits the credit authorization information to the system 21 through the first communication media 31, and the credit authorization information is encrypted by a encryption means in advance and then transmitted. After the system 21 receiving the encrypted information, a decode means 219 decodes the information to unencrypted code.

The database 211 at least includes: consumer credit information (ex. credit card number, expiration date, holder name, contact information, etc.), check code (including a member code and a cipher code, both of them may be applied in advance.), order list from consumer 23 and actual delivery and fund-request list from merchant 22, furthermore, the database 211 are able to that consumer 23 connects to and utilizes the system 21 via the first communication media 31 for checking those lists.

The comparison means 215 compares the check code of credit authorization information and the check code of database 211, and produces an identified application information for bank 24 depending on the comparison result. On the other hand, comparison means 215 utilizes that each merchant is with only one URL to prove merchant identification, another words, the system 21 receives a media URL of consumer requests (a balance page as usual), and the balance page is normally with embedded codes, which includes a merchant code representing the merchant 22. Before authorization being made, comparison means 215 compares the merchant code in the embedded codes with a merchant code in database 211 to identify the merchant code in embedded codes.

The second communication channel 216 communicates to bank 24 via the second communication media 32. The comparison 215 could send application information to bank 24 via the second communication media for proving credit limit, meantime, and receives authorization result from bank 24 via the second communication media 32. In the preferred embodiment, the first communication media 31 and the second communication media 32 are not the same media. For example, the first communication media 31 is about Internet, it is convenient for consumers 23 and major merchants 22; the second communication media 32 is about special line for increasing security and transmit speed. Another embodiment, the two communication medias can be the same one.

For order means 217, a record of delivery produced by authorization result which type is possible an e-mail, real time fax, word file, XML or real time word string and is sent to merchant 22 through first communication media 31 and auto reply means 213. The record includes date, order number, receiver name, receiver address, model number, price, quantity, total order amount, authorization result, etc. Meanwhile, consumer 23 receives the order and authorization information from auto reply means 213 as well.

For the fund-request 218, which receives fund-request from merchant 22. Depending on actual delivery conditions, fund-request is then made; on the contrary, find-request is not based on total amount of consumer 23 initially purchasing on merchant 22. Another words, fund-request from merchant 22 is produced by that goods number (or goods name) of actual delivery and delivery quantity are transmitted to the system 21 and actual fund-request amount is calculated by fund-request means 218, thus the fund-request can be made to bank 24. Merchant 22 does not request to bank 24, and it goes through e-commerce business system 21 to ask to bank 24, bank 24 inquires to consumer 23 at actual amount. (Note: some conditions are that systems or banks deduct or add additional process charge to make different amounts.)

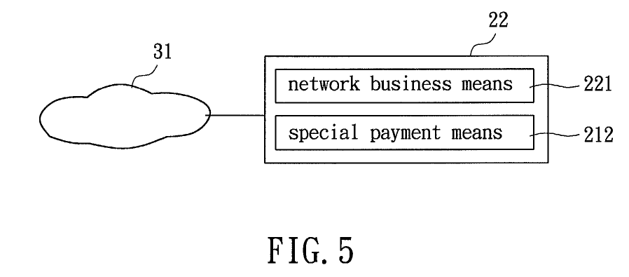

Please refer to FIG. 5, which is a scheme of merchant 22 system of e-commerce business system in the invention. The merchant 22 system connects to the first communication media 31 and the merchant 22 system consists of: a network business means 221 and a special payment means 212.

For the network business means 221, which is the sales means in prior art and it provides general consumers 23 to connect to merchant 22 system via the first communication media 31, another words, it is the present shopping website means (or web means) and generally exist on Internet. By the reason of prior art and the network business means 221 are suitable for most of websites, thus no more description is for that.

One of features of the merchant 22 system is the special payment means 212. Comparing with traditional technology, the traditional shopping websites (or webs) need to install a complicate payment gateway or payment gateway server for connecting with credit card issuing bank to do real time credit authorization check. As a matter of fact, the merchant 22 system is not necessary to have its own payment gateway server. Contrarily, the merchant 22 system only need to do is that adding an embedded code into original shopping website (or web) to attach a call-to-start code of the special payment means 212, thus the connection between the merchant 22 system and the system 21 is done. In the preferred embodiment, the call-to-start code in the special payment means 212 is a series execution code (the embedded code provided by the system), and the call-to-start code is appeared with icon type on website of merchant 22. When proceeding payment and clicking the icon, the special payment means 212 is start and thus another independent web is pop-up immediately. The pop-up web offers a payment means and execution procedure for consumer 23 inputting credit authorization information, continuously the information is encrypted to encryption for transmitting to e-commerce business system 21. The special payment means 212 adopts applet interface for consumer convenience. To transmit any information package uses standard SSL 128 bits encryption for complete encryption. The code for the special payment means 212 is written by JAVA language, browser supporting JAVA JVM 1.1 and above version can be compatible, and no more upgraded browser or download other plug-in codes.

The above description is about that the system and method for e-commerce business of the invention is the e-commerce business system that effectively combines membership function, cash flow, logistic and information flow. The payment means is through “Member Number Management”, “Member Business Cipher Code Check” and “The Direct Security Encryption Means Between Card Holder and The System” to solve the problem of real time credit card authorization in cash flow of e-commerce business. Another point, credit card fund-request file is produced depending on actual delivery condition of order list, and the shortness of ordered goods not in stock, refund process and goods delivery and fund-requests time after time is totally figure out. The consumer right is protected on network purchasing. Comparing to prior art, the invention features can be mentioned as following:

A. Member Number Management:

1.Consumer adopts member number to be instead of credit card number for network business.

2.Consumer may register in the system to be as a member, and credit card number may be stored in security system, thus when dealing with web shopping merchants, the only process is to input member number and cipher code on special payment means, and identified authorization is issued from bank via the system for finishing the business.

B. Member Business Cipher Code Check:

When consumer engages e-commerce payment, to input member cipher code firstly for checking consumer identification, the system send detail order to bank for credit card business authorization process if member cipher code passed. Because of cipher code check, e-commerce business risk can be lowered effectively.

Three channels for card holder receiving cipher code are as following:

1. When card holder applying the system member via network, card holder sets up cipher code by himself and inputs required information to some columns for card issuing bank to check consumer identification. The system immediately confirms with issuing bank whether the information is true or not. After the information being proved, the cipher code input by the aforesaid card holder becomes the key while the card holder enters the system.

2. Card holder physically goes to issuing bank counter for applying cipher code.

3. Card issuing bank sends cipher code to card holder by written notice or e-mail.

The management styles for cipher code are as following:

1. Committing the system to manage and check.

2. Issuing bank manages cipher code directly, and the system connects to issuing bank for check while network business being processed.

In the preferred embodiment of the invention, if credit card issuing bank authorizes cipher code to card holder, the cipher code is the base that issuing bank check whether card holder is true or false. Later on, when card holder utilizes the credit card to deal with network merchants, the cipher code provided by the card holder is to let issuing bank confirming the card holder status. The card holder does not input credit card number and some related information, not like the prior art.

C. The secure encryption means for card holder and the system:

1. Because of the payment means of the system, all of credit card and personal information are no longer transmitted and stored by network merchants. Therefore merchants cannot record the above information.

2. All information exchanged by the system are adopts 128 bits SSL for encryption transmitting.

1. Hackers cannot steal any information from anywhere.

D. Credit card fund-request file produced depending on actual ordered items delivery:

The Credit card fund-request file produced depending on actual ordered items delivery totally figures out the shortness of ordered goods not in stock, refund process and goods delivery and fund-requests time after time. The consumer right on network business is protected. Another words, credit card payment is made by actual delivered dates and amounts. For instance, some items of an order are assigned to be delivered time after time; the system individually has a fund-request to bank based on every actual delivery.

It may thus be seen that the objects of the present invention set forth herein, as well as those made apparent from the foregoing description, are efficiently attained. While the preferred embodiments of the invention have been set forth for purpose of disclosure, modifications of the disclosed embodiment of the invention as well as other embodiment thereof may occur to those skilled in the art. Accordingly, the appended claims are intended to cover all embodiments that do not depart from the spirit and scope of the invention.

What is claimed is:

1. A system for e-commerce business, which connects to at least a consumer and a merchant via a first communication media, and also connects to a bank via a second communication media, the system includes:
a first communication channel, which communicates with the first communication media and at least receives a credit authorization information, including at least a check mode, from consumer via the first communication media;
a database, at least stores a consumer credit information and a check mode;
a comparison means, which compares the check mode of the credit authorization information with the check mode of the database, and a comparison result is then generated, which is an application authorization information for bank identifying;
a second communication channel, which at least communicates to bank via second communication media, the comparison means transmits the application information to bank via second communication channel, and receives an authorization result from bank via second communication channel; and
an order means, which generates a record based on the authorization result and transmits the record to merchant.

2. The system for e-commerce business as cited in claim 1, wherein, the consumer purchases merchandises in merchant via the first communication media, and checks the authorization result from bank via the system, the merchant proceeds fund-request to bank via the system.

3. The system for e-commerce business as cited in claim 2, wherein, a fund-request means that receives a fund-request from merchant.

4. The system for e-commerce business as cited in claim 3, wherein, the fund-request is based on actual delivery from merchants, and not depending on initial consumer order.

5. The system for e-commerce business as cited in claim 4, wherein, the database stores consumer order list, merchant actual deliver and fund-request list for consumer checking via first communication media.

6. The system for e-commerce business as cited in claim 1, wherein, the check code includes a member code and a cipher code.

7. The system for e-commerce business as cited in claim 1, wherein, the check code includes credit card information.

8. The system for e-commerce business as cited in claim 1, wherein, the credit authorization information is firstly encrypted by an encryption means and transmitted to the system from consumer via first communication media, the system further includes:
a decode means, which is able to decodes the encrypted credit authorization information.

9. The system for e-commerce business as cited in claim 1, wherein, the credit information includes at least credit card information.

10. The system for e-commerce business as cited in claim 1, wherein, the first communication media is Internet.

11. The system for e-commerce business as cited in claim 1, wherein, the system sends delivery information to merchant based on the authorization result.

12. The system for e-commerce business as cited in claim 1, wherein, the first communication media and the second communication media are not the same communication media.

13. The system for e-commerce business as cited in claim 1, wherein, the first communication media and the second communication media are the same communication media.

14. A merchant system which cooperates with the system for e-commerce business as cited in claim 1, the merchant system connects to the first communication media, the merchant system includes:
a network business means, which offers a sales means for consumer connecting to merchant system via first communication media and choosing wanted merchandises; and
a special payment means, which offers a payment means for consumer inputting credit authorization information and transmitting the information to the system.

15. A method for e-commerce business, which includes:
(A) Offering a system for e-commerce business, the system includes at least a communication channel for communicating with a consumer, a merchant and a bank, the system is with at least a database that stores at least a consumer credit information and a check code;
(B) Receiving a credit authorization information from communication channel, and the credit authorization information includes at least a check code;
(C) Comparing the check code of the credit authorization information with the check code of the database, and an application authorization information for bank identifying is then generated based on a comparison result;
(D) Transmitting the application authorization information to bank via communication channel, and receiving an authorization result from bank;
(E) A record is then generated based on the authorization result and the record is transmitted to merchant.

16. The method for e-commerce business as cited in claim 15, wherein, the credit authorization information is transmitted to the system by consumer, and is not stored in the merchant.

17. The method for e-commerce business as cited in claim 15, wherein, the credit authorization information is encrypted by an encryption means, and then transmitted to the e-commerce business system by consumer.

18. The method for e-commerce business as cited in claim 15, wherein, the consumer purchases merchandises in merchant via a first communication media, and checks the authorization result from bank via the system, the merchant proceeds fund-request to bank via the e-commerce business system.

19. The method for e-commerce business as cited in claim 18, wherein, the fund-request is based on actual delivery from merchants, and not depending on initial consumer order.

20. The method for e-commerce business as cited in claim 19, wherein, the database stores consumer order list, merchant actual deliver and fund-request list for consumer checking via first communication media.
